(19) United States
(12) Patent Application Publication
(10) Pub. No.: US 2003/0141645 A1
(43) Pub. Date: Jul. 31, 2003

(54) Mold holder of a molding machine and structure of combination

(76) Inventor: Jui-Hsiang Wang, Yung Kang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/351,394

(22) Filed: Jan. 27, 2003

(30) Foreign Application Priority Data
Jan. 30, 2002 (TW) 091200963

(51) Int. Cl. B23Q 3/02

(52) U.S. Cl. 269/91

(57) ABSTRACT

A mold holder of an injection molding machine includes a base, several clamping blocks, and nuts. The base has cylindrical channels extending inwards from a lateral edge thereof, and trenches formed on an upper side; the elongated trenches are above, and in communication with, respective cylindrical channels. Each of the nuts has a cylindrical shape and a screw hole on a curved side thereof; the cylindrical nuts are fitted in the cylindrical channels, and bolts are tightly connected to other common nuts, the clamping blocks, and the cylindrical nuts so that a mold can be held on the base with the clamping blocks being pressed against it.

### BACKGROUND OF THE INVENTION

1. Field of the invention

The present invention relates to a mold holder for holding a mold in position, more particularly one, which can be used for fixing various molds in position, and allows a mold to be removed from it relatively easily, and which can be made and assembled relatively easily and is made with such a form as to have increased strength and long service life.

2. Brief Description of the Prior Art

Referring to FIGS. 4, 5, and 6, a conventional mold holder of an injection molding machine has a base 2 formed with several elongated trenches 21 having T-shaped cross-section, T-shaped nuts 22 for fitting with the elongated trenches 21, and clamping blocks 23 for pressing a mold against the base 2; bolts 24 are screwed into the T-shaped nuts 22, passed through the clamping blocks 23, and screwed into nuts (not numbered), and a mold 3 is positioned between the base 2 and the clamping blocks 23 at edges thereof so that the mold 3 can be fixed in position by means of screwing the nuts and the bolts 24 tight.

However, the mold holder is found to have disadvantages in both production and use as followings:

1. A shaping knife has to be used and moved from an edge of the base 2 towards an inner portion repeatedly to form a T-shaped elongated trench 21 therefore it is relatively difficult to produce the base 2.

2. Smoothness and relatively high precision are required on various sides of T-shaped elongated trenches 21 for allowing T-shaped nuts 22 to be inserted into the trenches 21 therefore the cost of forming the trenches 21 is very high.

3. Referring to FIG. 6, among the various sides of the trenches 21, there are two sides 211, which will come into contact with T-shaped nuts 22; the sides 211 have right angles at the edges, and have relatively sharp concavities; because the sharp concavities are those portions, upon which stress concentration will be formed when T-shaped nuts 22 are tightly joined to the base 2, they are prone to deform or even crack when the mold holder is being used.

4. The distance from the sides 211 to the upper surface of the base 2 has to be increased lest the right angles and the sharp concavities at the edges of the sides 211 will crack or deform. Consequently, the whole base 2 has to be provided with a bigger thickness, causing increase to the cost of the material of the mold holder.

5. T-shaped nuts 22 also have to be formed with smoothness and precision to be fitted into the trenches 21 therefore the cost of forming the T-shaped nuts 22 is very high.

6. Relatively much force will be exerted on the lower wider portions of the T-shaped nuts 22 when the mold holder is being used to hold a mold in position therefore the lower wider portions of the T-shaped nuts 22 have to be formed with enough thickness lest they will crack or deform. Consequently, the base 2 has to be formed with deeper trenches 21 to cause increased difficulty to formation thereof, and in turn, the whole base 2 has to be provided with a bigger thickness, causing increase to the cost of the material.

7. The base 2 have several gaps at the edges thereof because of the T-shaped elongated trenches 21 formed thereon, and which will cause the intensity of stress of the whole base 2 to change.

### SUMMARY OF THE INVENTION

It is a main object of the present invention to provide a mold holder of a molding machine, which includes a base, several clamping blocks, and nuts; the base has cylindrical channels extending from a lateral edge, which can be formed relatively easily; trenches are formed above, and in communication with, respective cylindrical channels; each of the nuts has a cylindrical shape and a screw hole on a curved side thereof; the nuts are fitted in the cylindrical channels, and bolts are tightly connected to other common nuts, the clamping blocks, and screwed into the cylindrical nuts for holding a mold in position.

It is another object of the present invention to provide a base part to the mold holder of the present invention, which is formed with cylindrical trenches instead of ones having T-shaped cross-section, so that those sides of the base above the trenches are less likely to crack or deform.

It is yet another object of the present invention to provide cylindrical nuts to be fitted into the cylindrical trenches, which is easily available, and can be made more easily and with bigger tolerance than T-shaped ones to be fitted in the trenches of the prior art mold holder. In addition, the trenches of the present base are not extended to the lateral edges of the base therefore formation of the cylindrical channels and the trenches will not cause the strength of the whole base to reduce, and in turn, thickness and weight and material cost of the base, and power used in manufacturing can be reduced while sufficient strength of the base is maintained.

### BRIEF DESCRIPTION OF THE DRAWINGS

The present invention will be better understood by reference to the accompanying drawings, wherein

FIG. 1 is an exploded perspective view of the mold holder according to the present invention,

FIG. 2 is a plan of the base of the mold holder according to the present invention,

FIG. 3 is a cross-sectional view of the mold holder according to the present invention,

FIG. 4 is an exploded perspective view of the conventional mold holder as described in the Background,

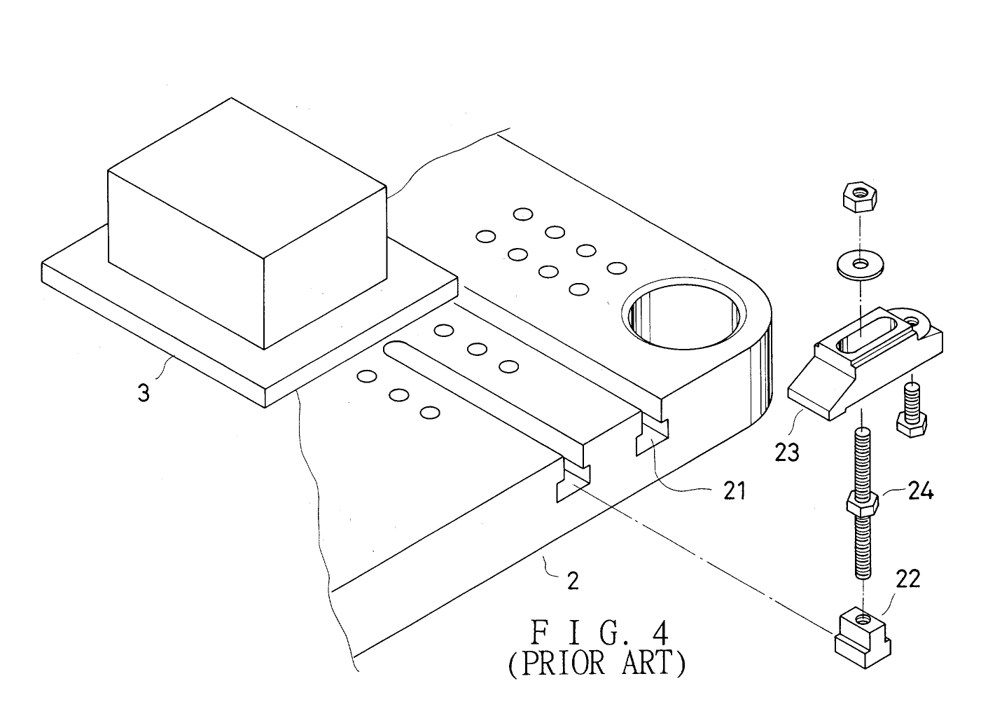

FIG. 5 is a plan of the base of the conventional mold holder; and,

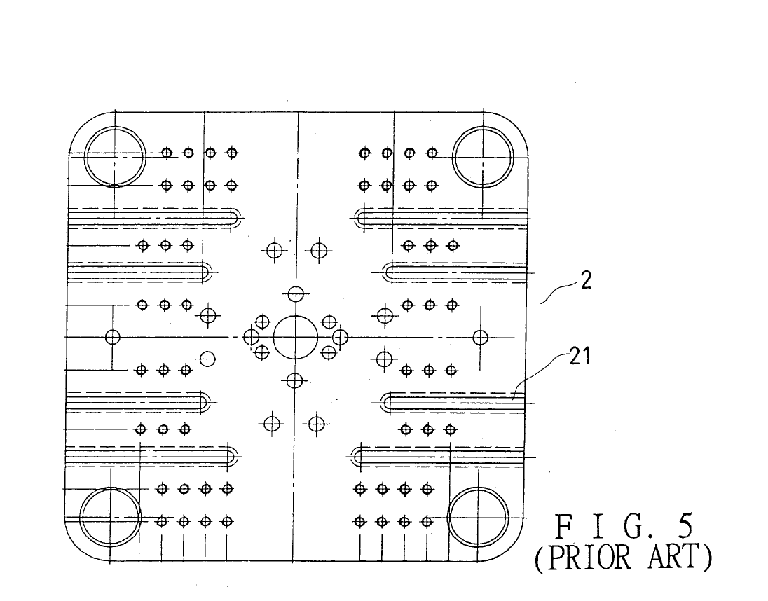

FIG. 6 is a cross-sectional view of the conventional mold holder.

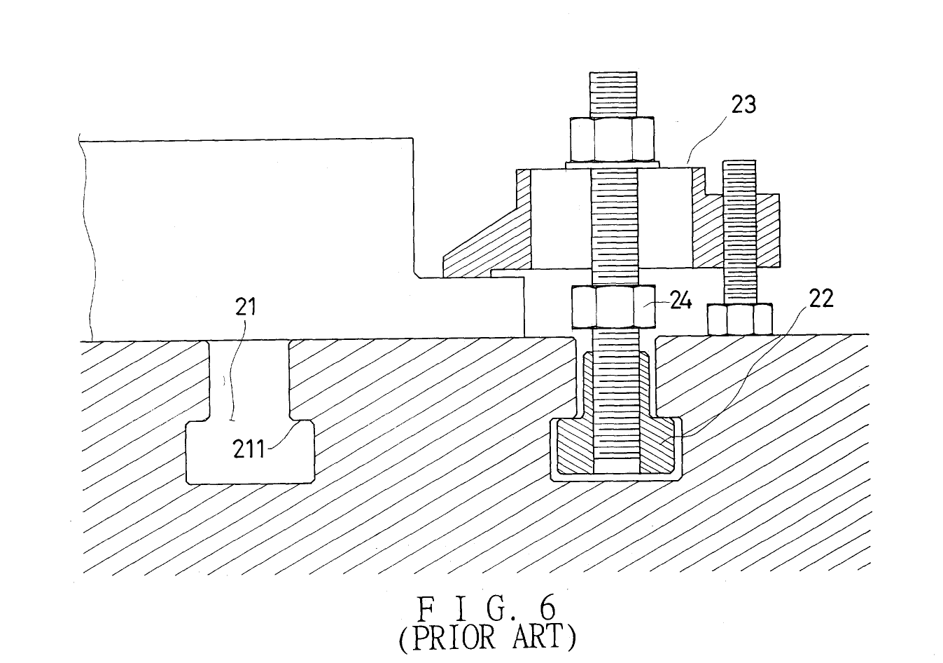

### DETAILED DESCRIPTION OF THE PREFERRED EMBODIMENTS

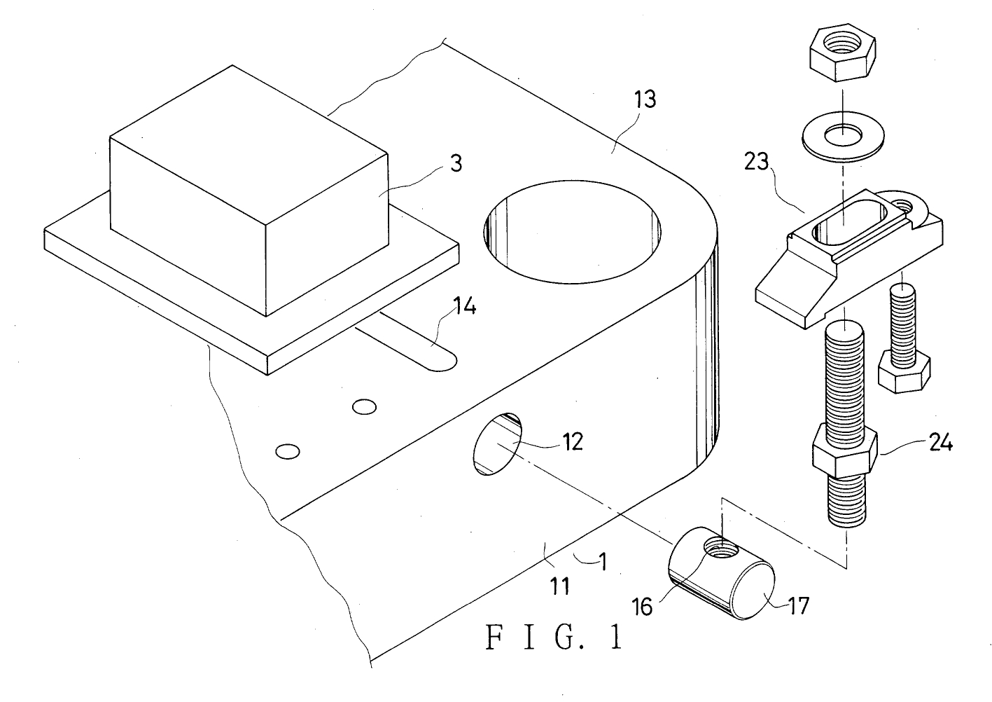

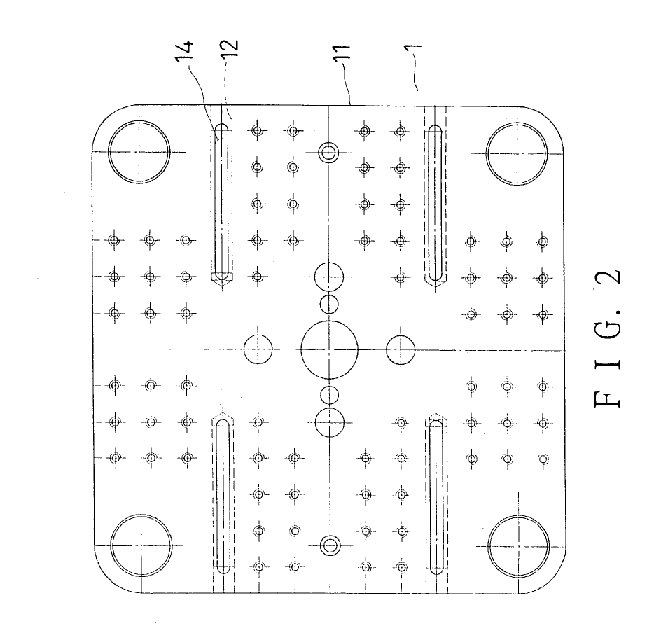

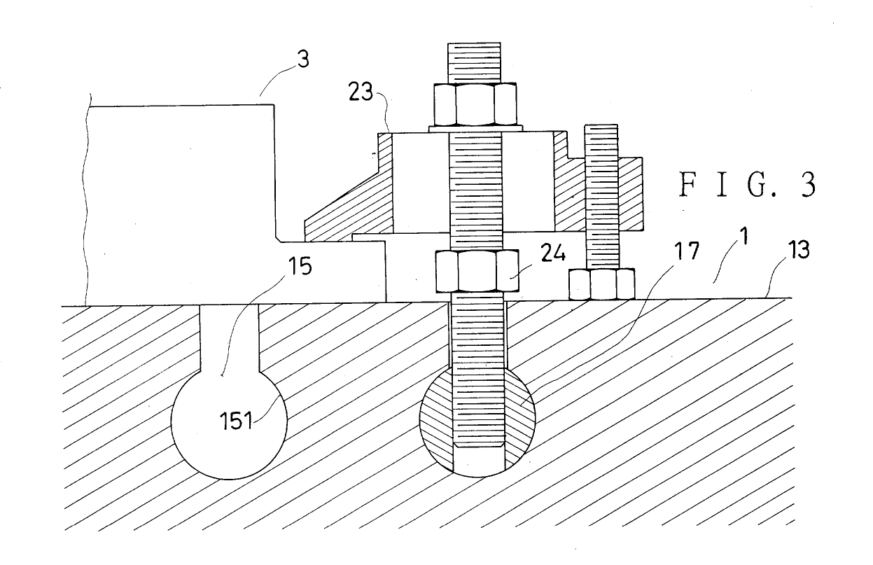

Referring to FIGS. 1, and 2, a mold holder of the present invention includes a base 1, several cylindrical nuts 17, and clamping blocks 23 for pressing a mold against the base 1; the base 1 is formed with several elongated cylindrical channels 12 by means of drilling machines, and elongated trenches 14 on an upper side thereof, which are right above, and in communication with, corresponding elongated cylindrical channels 12 so that the cross-section of a channel 12 and the corresponding trench 14 has a lower circular shape and an upper rectangular shape, as shown in FIG. 3; the elongated cylindrical channels 12 are extended to lateral edges 11 of the base 1 while the elongated trenches 14 are preferably not, i.e. outward ends of the elongated trenches 14 are preferably a distance from the lateral edge 11 of the base 1.

The cylindrical nuts 17 are to fit with the cylindrical channels 12, and each has a screw hole 16 formed on the curve side thereof.

To hold a mold on the present mold holder, first the cylindrical nuts 17 are passed into the passed through the cylindrical channels 12. Then, bolts 24 are screwed into the cylindrical nuts 17, the clamping blocks 23, and screwed into nuts (not numbered), and a mold 3 is positioned between the base 1 and the clamping blocks 23 at edges thereof so that the mold 3 can be fixed in position by means of screwing the nuts and the bolts 24 tight.

From the above description, it can be easily understood that the mold holder of the present invention has advantages over the above-mentioned conventional one as followings:

1. Those sides 151 of the base 1 which the cylindrical nuts 17 are pressed against have curved shape instead of flat shape, and don't have sharp cavities therefore they have smaller stress concentration, and are less likely to deform or crack when the mold holder is being used. In other words, the channels and trenches 12, 14 have bigger strength.

2. According to the same reason mentioned above, distance from the sides 151 to the upper side of the base 1 can be reduced to be smaller than that of the prior mold holder base 2 while sufficient strength of the base 1 is maintained. Consequently, the thickness of the whole base 1 is smaller, and the base 1 can be made in shorter time and at lower cost.

3. Cylindrical channels 12 of the base 1 are formed by means of drilling, which is relatively easy and costs less labor as compared with the way the prior T-shaped trenches are formed, and trenches 14 can also be formed easily by means of cutting machines after the cylindrical channels 12 are formed therefore the manufacturing cost of the present base 1 is lower.

4. Although the cylindrical channels 12 are extended to lateral edges 11 of the base 1, the edge 11 of the base 1 doesn't have gaps extending down from the upper side thereof like the prior art base 2 because the trenches 14 are not extended to the lateral edges 11. Therefore, the cylindrical channels 12 and the trenches 14 will not cause the strength of the whole base 1 to reduce, and in turn, thickness and weight and material cost of the base 1, and power used in manufacturing can be reduced while sufficient strength of the base 1 is maintained.

5. Being cylindrical, the nuts 17 are much more easily available, and can be made more easily and with bigger tolerance than the prior art T-shaped nuts 22.

6. If the base 1 is used in a vertical orientation relative to the ground with the channels and trenches 12, 14 being also vertical, a mold held in position with the present mold holder can't possibly slide down to fall off the base 1 because the trenches 14 are not extended to the edges 11 of the base 1, and the bolts 24 will be stopped from moving by the edges 11.

What is claimed is:

1. An improvement on a mold holder of a molding machine and structure of combination, comprising
a base having a plurality of elongated cylindrical channels extending inwards from a lateral edge thereof, and elongated trenches formed on an upper side; the elongated trenches being above, and in communication with, respective ones of the cylindrical channels; and,
a plurality of nuts, each having a cylindrical shape and a screw hole on a curved side thereof; the nuts being fitted in the cylindrical channels for tight connection to bolts and clamping blocks used for holding a mold in position on the base.

2. The mold holder of a molding machine and structure of combination as claimed in claim 1, wherein outward ends of the elongated trenches is a distance from the lateral edge of the base.

3. The mold holder of a molding machine and structure of combination as claimed in claim 1, wherein the elongated trenches extend to the lateral edge of the base.
